(19) United States
(12) Patent Application Publication
(10) Pub. No.: US 2019/0154515 A1
(43) Pub. Date: May 23, 2019

(54) DEVICE AND METHOD FOR MEASURING END SURFACE TURNING TEMPERATURE

(71) Applicant: Dalian University of Technology, Dalian City, Liaoning Province (CN)

(72) Inventors: Chunzheng DUAN, Dalian City, Liaoning Province (CN); Wenneng KOU, Dalian City, Liaoning Province (CN); Yuwen SUN, Dalian City, Liaoning Province (CN); Fangyuan ZHANG, Dalian City, Liaoning Province (CN); Penghe LIU, Dalian City, Liaoning Province (CN); Wei SUN, Dalian City, Liaoning Province (CN)

(21) Appl. No.: 16/099,536

(22) PCT Filed: Oct. 19, 2017
(86) PCT No.: PCT/CN2017/106791

§ 371 Date: Nov. 7, 2018

(30) Foreign Application Priority Data
Mar. 13, 2017 (CN) 201710145432.5

(51) Int. Cl. G01K 1/14; G01K 7/02; G01K 1/02

(52) U.S. Cl. CPC G01K 1/143; G01K 1/024; G01K 7/023

(57) ABSTRACT

The invention provides a device and method for measuring the temperature of end face turning, which belong to the technical field of cutting and are applicable for measuring the temperature of cutting area during end surface turning. The device comprises a thermocouple sensor, a slip ring and a specially designed experiment workpiece. The circular ribs designed on the experiment workpiece transform the end surface turning into cylindrical turning. The design of a through hole and a blind hole makes the thermocouple sensor reasonably buried in the workpiece, which improves the safety of the turning process and the stability of signals. At the same time, the interference between devices is eliminated by using the slip ring structure. A temperature signal is collected by a data collection card via the slip ring and transmitted to a computer, and finally, a relatively accurate end surface turning temperature is obtained. The present invention has simple structure and easy operation, and provides a good device and method for realizing accurate measurement of end surface turning temperature.

### TECHNICAL FIELD

The present invention belongs to the technical field of cutting, and relates to a device and method for measuring end surface turning temperature.

### BACKGROUND

Turning temperature rise is an important physical phenomenon during turning. Part of the heat generated in the turning process is dissipated in the surrounding medium, and the rest is passed to turning tool, chips and workpiece to obtain a certain temperature. Different turning temperatures can result in different thermal deformation of turning tools and workpieces, thus affecting the machining precision of parts and tool life, and reducing the production efficiency. At the same time, the microstructure of metal material will be changed according to different turning temperatures, so turning temperature is an important factor affecting the surface quality of the workpieces. Therefore, it is possible to further develop the turning processing by studying the turning temperature. In scientific research, orthogonal turning is a kind of cutting method which is often used in order to facilitate calculation and modeling, and end surface cutting can easily realize orthogonal cutting. In addition, the research on the microstructure change of material is usually performed by extracting the microstructure of material after orthogonal turning. Therefore, studying a device and method for measuring end surface turning temperature has great significance for studying turning process.

At present, there are many methods for measuring turning temperature, including thermocouple method, ray radiation method, thermal radiation method and metallographic structure method. Among them, thermocouple method is a relatively mature and commonly used method for measuring turning temperature. The principle is that two different conductor materials are connected and there is a temperature difference at the junction, which can generate an overflow electromotive force due to the overflow of surface electrons and form a thermoelectric potential. This is called the See beck effect. Because the thermoelectric potential formed by two specific materials in certain temperature conditions is certain, the thermal state and temperature change of an area measured can be determined according to the magnitude of the thermoelectric potential. However, when measuring turning temperature, due to the high-speed rotation of the workpiece, there is a lot of inconvenience in temperature measurement. In particular, when measuring end surface temperature, there is a large centrifugal force which can produce certain signal interference, and devices are easily interfered with each other. As a result, the existing turning temperature measuring devices have the shortcomings that the structure is complex and the measurement result is not accurate enough.

### SUMMARY

To solve the above-mentioned problems, the present invention provides a device which has simple structure, easy operation and high measurement accuracy and is particularly suitable for measuring end surface turning temperature and a measurement method.

The technical solution of the present invention is as follows:

A device for measuring end surface cutting temperature, comprising a thermocouple sensor 5, a slip ring 9, a temperature signal processing end 16 and an experiment workpiece 1; the experiment workpiece 1 has a cylindrical shape, with a holding space reserved on the left side, a space equal to the width of a turning tool reserved on the right side, and prominent circular ribs 2 in the middle; each circular rib 2 has two holes, one is a blind hole 3, and the other is a through hole 4; the central axes of the blind hole 3 and the through hole 4 are on the same line; a probe of the thermocouple sensor 5 is arranged in the blind hole 3, and the other side of the thermocouple sensor 5 is connected with a slip ring rotor 8 through an input wire 6; the slip ring rotor 8 is located outside the right side of the experiment workpiece 1, the two are fixed on a rotor fixing groove 12 through screws 7, and the slip ring rotor 8 is maintained coaxial with the experiment workpiece 1 to counteract the centrifugal force; a slip ring stator 9 is connected with the temperature signal processing end 16 through an output wire 15, and at the same time, the slip ring stator 9 is fixed on a fixing bracket 13 through a baffle plate 14 to prevent from rotating; and the cutting edge 10 of the turning tool 11 is used for turning the circular ribs 2.

The number of the circular ribs 2 on the experiment workpiece 1 is more than two; the height of the circular ribs 2 is from 5 to 15 mm and is gradually reduced from left to right; the thickness of the circular ribs 2 is not greater than the width of the cutting edge 10, so that cylindrical turning process can be made equivalent to end surface turning of 90° turning tool; and the grooves are formed in the circular ribs 2 by a slotting cutter and maintained a certain width.

The blind hole 3 and the through hole 4 are processed by an electrical discharge drilling machine, the diameter of the through hole 4 is larger than that of the blind hole 3, and then the blind hole 3 of which the diameter is equivalent to that of the probe of the thermocouple sensor 5 is processed via the through hole 4; this is mostly done to prevent the discharge interference of upper-layer through hole 4 when the blind hole 3 is processed. The holes of each circular rib 2 are distributed at a certain angle and perpendicular to the axial plane, which is convenient to install a thermocouple probe and balance the centrifugal force.

A device and measurement method for measuring cutting temperature of end surface, comprising the following steps:

(1) Installing a device; tightening and fixing the device; and connecting a signal output wire to a data collection card;

(2) Aligning the cutting edge to the rightmost circular rib 2; setting the cutting parameters according to the data target; collecting data via the data collection card at the same time; and feeding the turning tool gradually until the probe of the thermocouple sensor 5 is cut off and cannot collect temperature data;

(3) Repeating the above operations to collect the temperature data obtained on each circular rib 2;

(4) Taking the fluctuation data in the last several cycles of each set of temperature curves; eliminating obvious interference data; obtaining the maximum temperature value measured in each set; making intercomparsion; and taking the maximum value, thus a relatively accurate end surface turning temperature is obtained.

The present invention has the following beneficial effects: the temperature data of the cutting area during turning process was collected directly by the probe of the thermocouple sensor 5 which is buried in the experiment workpiece 1, and the turning tool is fed gradually until the probe is cut off, so accurate measurement of turning temperature is realized. The special circular ribs 2 of the device transform the 90 end surface turning into similar cylindrical turning, so the experiment process becomes more convenient. This device guarantees the safety of the thermocouple sensor 5 by burying it in the device, and the experiment workpiece 1 itself has a certain shielding effect, so signal interference is reduced. Through the designing rotor 8, the interference problem between devices can be eliminated, and high-speed rotation of the experiment workpiece 1 can be guaranteed. The device of the present invention has simple structure and easy installation and operation, which can realize accurate measurement of turning temperature with certain turning parameters.

### DESCRIPTION OF DRAWINGS

FIG. 1 is a structural schematic diagram of the device of the present invention.

FIG. 2 is a structural schematic diagram of the device of the present invention from the right view.

FIG. 3 is a structural schematic diagram of the device of the present invention after experiment.

### DETAILED DESCRIPTION

Specific embodiment of the present invention is further described below in combination with appended drawings and the technical solution.

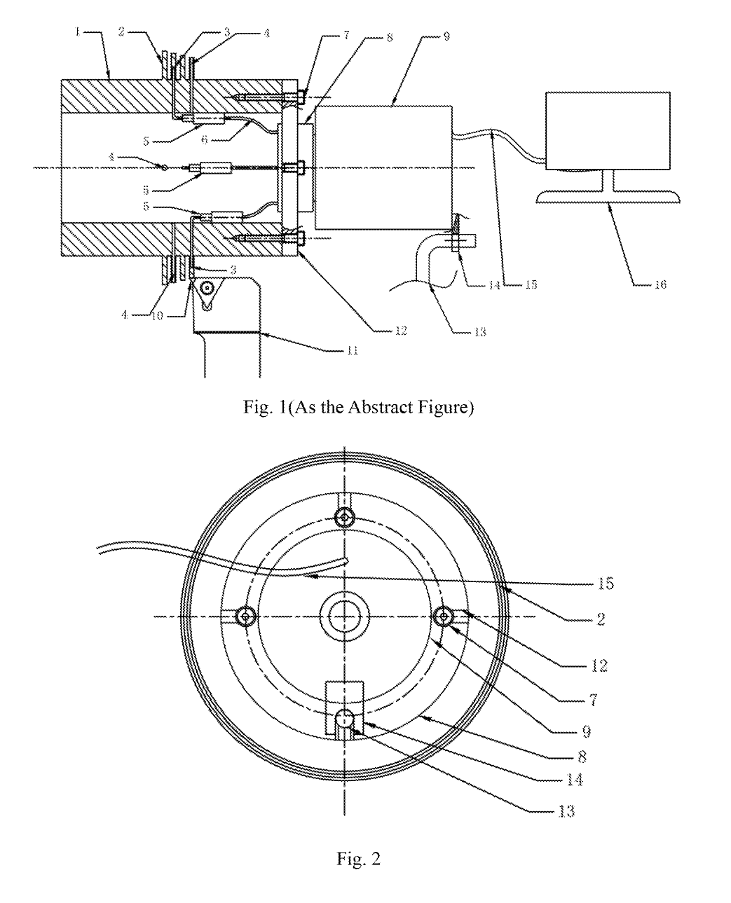

As shown in FIG. 1, the device comprises a thermocouple sensor 5, a slip ring 9, a temperature signal processing end 16 and an experiment workpiece 1; the experiment workpiece 1 has a cylindrical shape, with a holding space reserved on the left side, a space equal to the width of a turning tool reserved on the right side, and the prominent circular ribs 2 in the middle. The number of the circular ribs 2 on the experiment workpiece 1 is more than two; the height of the circular ribs 2 is from 5 to 15 mm and is gradually reduced from left to right; the thickness of the circular ribs 2 is not greater than the width of the cutting edge 10, so that cylindrical turning process can be made equivalent to 90° end surface turning; and the grooves in the circular ribs 2 are formed by a slotting cutter and maintained a certain width. Each circular rib 2 has two holes, one is a blind hole 3, and the other is a through hole 4; the central axes of the blind hole 3 and the through hole 4 are on the same line. The blind hole 3 and the through hole 4 are processed by an electrical discharge drilling machine, the diameter of the through hole 4 which is processed by one step is larger than that of the blind hole 3, and then the blind hole 3 of which the diameter is equivalent to that of the probe of the thermocouple sensor 5 is processed via the through hole 4; this is mostly done to prevent the discharge interference of upper-layer through hole 4 when the blind hole 3 is processed. The holes of each circular rib (2) are distributed at a certain angle and perpendicular to the axial plane, which is convenient to install a thermocouple probe and balance the centrifugal force. A probe of the thermocouple sensor 5 is arranged in the blind hole 3, and the other side of the thermocouple sensor 5 is connected with a slip ring rotor 8 through an input wire 6; the slip ring rotor 8 is located outside the right side of the experiment workpiece 1, the they are fixed on a rotor fixing groove 12 through screws 7, and the slip ring rotor 8 is maintained coaxial with the experiment workpiece 1 to counteract the centrifugal force; a slip ring stator 9 is connected with the temperature signal processing end 16 through an output wire 15, and at the same time, the slip ring stator 9 is fixed on a fixing bracket 13 through a baffle plate 14 and prevented from rotating; and the cutting edge 10 of the turning tool 11 is used to cutting the circular ribs 2. The temperature signal processing end 16 is a processing end with relatively high collection frequency, and preferably a synchronous signal collection card.

The device is installed on a machine tool, and the left end of the device is clamped by a three jaw chuck. The machine tool is started at a speed; the circular ribs 2 are turned by the cutting edge 10 with a corresponding feed; the collected temperature signal is changed along with the change of the distance between the turning tool and the probe of the thermocouple sensor 5; the temperature signal presents a wave shape after being processed by the temperature signal processing end 16; as the cutting amount of the circular ribs is increased, when the distance to the probe gets small, the peaks rise in turn; when the cutting edge 10 cuts through the probe, the data measured at this moment is the closest to the real turning temperature.

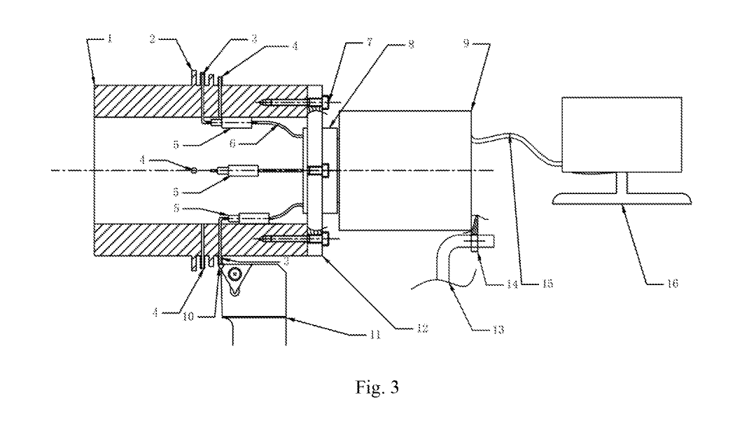

Further, the probe of the thermocouple sensor 5 is damaged and does not accept temperature data any more. However, because of the existence of data collection frequency, the distances from the positions of the last data collection to the probe are different, so that the final signal values are different, and therefore it is necessary to perform analysis according to the data obtained from multiple circular ribs 2. The structure of the device after the turning process is as shown in FIG. 3.

Further, the several sets of data obtained are imported and sorted at a terminal, and the data is smoothed and fitted. In experiment, the fluctuation data in the last several cycles of each set of temperature curves is taken; obvious interference data is eliminated; the maximum temperature value measured in each set is obtained; intercomparsion is made; and the maximum value is taken, thus a relatively accurate end surface turning temperature is obtained.

1. A device for measuring end surface cutting temperature, wherein the device comprises a thermocouple sensor, a slip ring, a temperature signal processing end and an experiment workpiece; the experiment workpiece has a cylindrical shape, with a clamping space reserved on the left side, the space equal to the width of a turning tool reserved on the right side, and the prominent circular ribs in the middle; each circular rib has two holes, one is a blind hole, and the other is a through hole; the central axes of the blind hole and the through hole are on the same line; a probe of the thermocouple sensor is arranged in the blind hole, and the other side of the thermocouple sensor is connected with a slip ring rotor through an input wire; the slip ring rotor is located outside the right side of the experiment workpiece, which are fixed on a rotor fixing groove through screws, and the slip ring rotor is maintained coaxial with the experiment workpiece to counteract centrifugal force; a slip ring stator is connected with the temperature signal processing end through an output wire, and at the same time, the slip ring stator is fixed on a fixing bracket through a baffle plate to prevent from rotating; and the cutting edge of the turning tool is used for turning the circular ribs.

2. The device in the claim 1, wherein the number of the circular ribs on the experiment workpiece is more than two; the height of the circular ribs is from 5 to 15 mm and is gradually reduced from left to right; the thickness of the circular ribs is not greater than the width of the cutting edge; and the grooves in the circular ribs are formed by a slotting cutter and maintained a certain width.

3. The device in the claim 1, wherein the blind hole and the through hole are processed by an electrical discharge drilling machine, the diameter of the through hole which is processed by one step is larger than that of the blind hole, and then the blind hole of which the diameter is equivalent to that of the probe of the thermocouple sensor is processed via the through hole; and the holes of each circular rib are distributed at a certain angle and perpendicular to the axial plane.

4. A measurement method for measuring end surface cutting temperature, comprising the following steps:
(1) Installing the device; tightening and fixing the device; and connecting a signal output wire to a data collection card;
(2) Aligning the cutting edge to the rightmost circular rib; setting the cutting parameters according to the data target; collecting data via the data collection card at the same time; and feeding the turning tool according to the set cutting feed until the probe of the thermocouple sensor is cut off and cannot collect temperature data;
(3) Repeating the above operations to collect the temperature data obtained on each circular rib;
(4) Processing the temperature data; taking the fluctuation data in the last several cycles of each set of temperature curves; eliminating obvious interference data; obtaining the maximum temperature value measured in each set; making intercomparsion; and taking the maximum value, thus a relatively accurate end surface turning temperature is obtained.
